(19) United States
(12) Patent Application Publication
(10) Pub. No.: US 2025/0179268 A1
(43) Pub. Date: Jun. 5, 2025

(54) Modified Halogen Free Flame Retardant Resins for Use in Electronic Devices

(71) Applicant: TE Connectivity Solutions GmbH, Schaffhausen (CH)

(72) Inventors: Dejie TAO, Fremont, CA (US); Lei Wang, San Jose, CA (US); Hyo Chang Yun, San Jose, CA (US); Ting Gao, Palo Alto, CA (US)

(73) Assignee: TE Connectivity Solutions GmbH, Schaffhausen (CH)

(21) Appl. No.: 18/526,308

(22) Filed: Dec. 1, 2023

(51) Int. Cl. C08K 3/22; C08L 83/04

(52) U.S. Cl. CPC C08K 3/22; C08L 83/04; C08K 2003/222; C08L 2201/02; C08L 2203/206

(57) ABSTRACT

A halogen free phosphorus flame retardant resin is disclosed. The halogen free phosphorus flame retardant resin is mixed with a metal oxide to form a modified halogen free phosphorus flame retardant. This modified halogen free phosphorus flame retardant composition can be used in electronic devices.

### FIELD OF THE INVENTION

The present invention relates to modified halogen free flame retardant resins for use in electronic devices. In particular, the invention is directed to a halogen free flame retardant resin with a metal oxide added to the resin which can be used in electronic devices. The modified halogen free flame retardant resin can include additional additives, as desired.

### BACKGROUND OF THE INVENTION

In order to meet fire safety requirements and diminish fire hazards, various flame retardants have been used. Flame retardants interrupt the pyrolysis of the underlying polymer. Adding flame retardants to polymers can help the final product made from such polymers from burning. However, the addition of the flame retardant to the polymer can possibly impact both the mechanical and electrical properties of the polymer.

UL 94 tests are used for measuring the burn rate and characteristics of polymeric materials. One method of determining flame retardancy is UL 94, the Standard for Tests for Flammability of Plastic Materials for Parts in Devices and Appliances. The UL 94 V-0 rating is based on a vertical burn test in which the self-extinguishing time of a polymer is determined. The UL 94 V-0 rating of a polymer indicates that the polymer will self-extinguish within 10 seconds with no dripping (UL 94, approved as ANSI/UL 94-2001 Apr. 11, 2001). It is important to have such a rating in many applications.

Various flame retardants have been used to improve the flammability rating of the underlying polymer in order to achieve the UL 94 rating. Traditionally, halogenated flame retardants have been used to improve the flammability rating of polymers. Halogenated flame retardants interrupt the gas phase of polymer combustion by producing free radicals such as dioxins and furans. Many of these halogenated flame retardants have environmental concerns and the use of these halogenated flame retardants in polymers is being phased out.

As a result, halogen free flame retardants have been used more and more to enhance the flame retardancy of polymers. Halogen free phosphorus based flame retardants are considered viable alternatives to halogenated flame retardants. These halogen free phosphorus based flame retardants are widely used due to their low toxicity, high efficiency, multiple flame retardant mechanisms and diverse molecular structures.

Unfortunately with the use of halogen free phosphorus based flame retardants, phosphoric acid is released when the flame retardant composition is subject to environmental conditions, such as high temperature or high humidity, as well as any combination of environmental conditions. Release of the acid may have a deleterious effect on surrounding components in a device if such flame retardant is used in the polymer.

In the paper, “The Study on Flame Retardancy Synergistic Mechanism of Magnesium Oxide for PA66/AlPi Composite”, Mater. Res. Express 6 (2019) 115317, the authors describe the important role of flame retardants in polyamide 6,6. The authors describe how magnesium oxide reacts with diethylphosphinic acid produced by the degradation of the aluminum diethylphosphinate.

There exists a need for a halogen free flame retardant resin which will not have a deleterious effect on polymers used in the surrounding components in a device and which can be used in multicomponent electronic devices.

### BRIEF DESCRIPTION OF THE DRAWINGS

The accompanying drawings, which are incorporated into and form a part of the specification, schematically illustrate one or more illustrative embodiments of the invention and, together with the general description given above and detailed description given below, serve to explain the principles of the invention, and wherein:

FIG. 1 is flow chart showing the Compression Set Test Procedure conducted on the FRIANYL A3 GF 30 V0 resin (as defined in the examples) made in accordance with the instant invention and testing with devices made from a silicone polymer composition.

FIG. 2 is a graph showing silicone tensile strain retention when in contact with the modified FRIANYL A3 GF 30 V0 resin (as defined in the examples) at 85° C. and 125° after 504 hours and 1008 hours.

FIG. 3 is a graph showing the aging impact on silicone compression set when silicone polymer composition is in contact with the modified FRIANYL A3 GF 30 V0 resin (as defined in the examples) at 85° C. and 125° C. after 1008 hours.

FIG. 4 is a graph showing silicone compression set when silicone polymer composition is in contact with two different modified flame retardant resins (as defined in the examples) of the instant invention at 0 hours and 504 hours at 125° C.

### SUMMARY OF THE INVENTION

An embodiment is directed to a modified halogen free phosphorus flame retardant resin comprising a halogen free phosphorus flame retardant and a metal oxide.

Another embodiment is related to an electronic device which includes a component made from a silicone polymer composition and a component made from a modified halogen free flame retardant resin of the instant invention.

Other features and advantages of the present invention will be apparent from the following more detailed description of the preferred embodiment, taken in conjunction with the accompanying drawings which illustrate, by way of example, the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The modified halogen free flame retardant resin of the instant invention comprises a halogen free phosphorus flame retardant resin mixed with a metal oxide. The modified halogen free phosphorus flame retardant resin should meet the UL 94 V-0 rating. An example of a commercially available halogen free phosphorus based flame retardant resin that can be used in the instant invention is FRIANYL A3 GF 30 V0, a polyamide based halogen free flame retardant composition, containing 30% glass fiber, available from Celanese.

The phosphorus based flame retardants that can be used in the modified halogen free flame retardant composition include but are not limited to phosphates, phosphonates, phosphinates, phosphinites, phosphonites, phosphites, phosphines, phosphine oxides, red phosphorus, and phosphonium compounds.

Alternatively, the phosphorus based flame retardant resins can be a mixture of a polymer with a phosphorus based flame retardant. The polymer used in the halogen free flame retardant resins can be any polymer desired. Preferably, the polymer itself meets the UL 94 V-0 rating. Examples of such suitable polymers include but are not limited to polyethylene, polypropylene, acrylonitrile butadiene styrene, polystyrene, polyketone, polybutylene terephthalate, polyamides, polyester, polyphenylene ether, polycarbonates, polysulfones, polyaryletherketones and polyethersulfones.

The halogen free phosphorus based flame retardant resin used in the instant invention is mixed with a metal oxide. Metal oxides are crystalline solids that contain a metal cation and oxide anion. They may react with water to form bases or with acids to form salts. Examples of metal oxides that can be used in this invention include but are not limited to aluminum oxide, antimony oxide, bismuth (III) oxide, calcium oxide, gallium (III) oxide, magnesium oxide, barium oxide, strontium oxide, zinc oxide, titanium (II) oxide, titanium (IV) dioxide, cerium dioxide, copper oxide, iron oxide, nickel oxide, manganese oxide, chromium oxide, or lead oxide. Preferably the metal oxide is magnesium oxide. The amount of metal oxide that is used in the modified halogen free phosphorus based flame retardant resins is in the range of about 0.5 to about 10 wt. % of the modified halogen free phosphorus based flame retardant resin.

Other conventional additives may be added to the halogen free flame retardant resins with the metal oxide. Examples of conventional additives include pigments, dyes, voiding agents, antistatic agents, foaming agents, plasticizers, radical scavengers, anti-blocking agents, anti-dust agents, antifouling agents, surface active agents, slip aids, optical brighteners, viscosity modifiers, gloss improvers, dispersion stabilizers, UV stabilizers, UV absorbers, antioxidants such as phenol antioxidants or amine antioxidants, lubricity agents, heat stabilizers, hydrolysis stabilizers, cross-linking activators, coupling agents, layered silicates, radio opacifiers (such as for example, but not limited to, barium sulfate), tungsten metal, non-oxide bismuth salts, colorants, reinforcing agents, adhesion promoters (such as for example, but not limited to, 2-hydroxyethyl-methacrylate-phosphate), impact strength modifiers, and any combination thereof. Such additives may be included in conventional amounts.

In another aspect, the invention relates to the preparation of the halogen free flame retardant resin with the metal oxide. The halogen free phosphorus flame retardant resin is first mixed with a metal oxide to form a modified halogen free phosphorus flame retardant resin. The modified halogen free phosphorus flame retardant resin, and any other additional additives are mixed together in particulate form using any conventional process to mix materials together. The mixing equipment can be any suitable equipment used in the art of mixing concentrated solids. Examples of such suitable equipment for the flame retardant resin include a batch mixer, such as a Brabender mixer, a Banbury mixer, a single extruder, a twin screw extruder, high speed centrifugal mixers, Henschel mixers, ribbon blenders, shakers, tube rollers and the like. The polymer, the modified halogen free phosphorus flame retardant and any desired additives may be heated, melted and compounded together using conventional processes.

Once the halogen free flame retardant resin is mixed with the desired additives, it can be further processed. The halogen free flame retardant resin can be extruded, injection molded, overmolded, compression molded, reaction injection molded, laminated, or 3D printed to form any desirable object.

There are many uses for the modified halogen free flame retardant resin of the instant invention. For example, the composition can be made into seals, gaskets, connectors, wires, cables, printed wire boards, or EMI shields as well as other electronic or computer components. The composition can be used to make electronic components which meet UL 94 standards, such smart phones, general automotive parts, electric motors, e-powertrains, batteries and battery enclosures, chargers for electric vehicles and other components of electric vehicles. In addition, the composition of the instant invention can be used to make molded parts.

Furthermore, the modified halogen free flame retardant resin of the instant invention can be used as a component in conjunction with other components in a device. For example, the modified halogen free flame retardant resin can be used as a component in an electrical device with a seal or gasket made from the silicone polymer composition.

The silicone polymers compositions which may be used in components in devices which also contain the halogen free flame retardant resin of the instant invention can be any silicone elastomer or polymer containing a chain made of alternating silicon and oxygen atoms. It can be a liquid silicone rubber (LSR), high consistency rubber (HCR), fluorosilicone, polyhedral oligomeric silsesquioxane (POSS), silicone polyamide, silicone polyurethane, silicone epoxy and other silicones. Examples of a suitable silicone are LSR 2660 and LSR7060 from GE Silicones. The type of silicone used is dependent upon the final end application. The silicone used in the silicone polymer composite can also contain other additives, dependent upon the final desired end use. Examples of suitable additives include fumed silica, antioxidants, flux or catalysts. Suitable antioxidants include phenol antioxidants or amine antioxidants. Examples of suitable fluxes include NH₄F, NH₄Cl, and Na₂B₄O₇. Possible catalysts that can be used include peroxide or platinum catalysts.

Silicone polymer compositions are particularly susceptible to acid environments. In particular, when used in conjunction with a component made from the modified halogen free flame retardant resin of the instant invention, the silicone polymer composition suffers an adverse effect. As illustrated below, hydrolysis of the siloxane bond under acidic conditions is a well-known process in silicone polymer compositions, especially in the presence of a strong nucleophile, such as water.

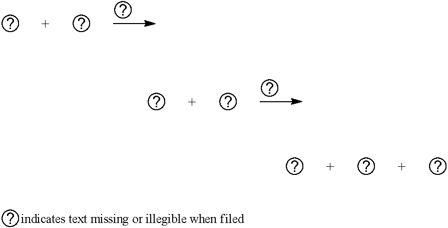

The resulting silanol group can be rejoined with another silanol group and thus forms a three-dimensional network. The formation of this three-dimensional network results in the reduced elasticity of silicone polymer composition. Environmental conditions speed up this process. For example, when the halogen free flame retardant is subject to environmental conditions such as temperature and humidity, phosphoric acid is released which attacks the device made from the silicone polymer composition. The use of the halogen free flame retardant of the instant invention prevents the formation of such an acid environment and prevents the degradation of components made with a silicone polymer in a device.

### EXAMPLES

The flame retardant composition used in the Examples is a FRIANYL A3 GF 30 V0 resin. The silicone polymer composition used as part of the Examples is a two-part liquid silicone rubber (LSR) containing 5% silicone oil and having 30 Shore A hardness. Part A and Part B of the LSR were mixed together using a FlackTek Speed Mixer DAC 150.1 FVZ mixer. After mixing, test coupons with a dimension of 13 mm in diameter and 6 mm in thickness were made using a compression molding process. 150 mm×150 mm×2 mm plaques were also prepared using compression molding. After curing the plaques were then cut into dumbbells using an ISO-37-2 die. The test coupons were then fully buried inside the FRIANYL A3 GF 30 V0 resin and aged at both 125° C. and 85° C./85% relative humidity (“RH”) for 504 and 1008 hours.

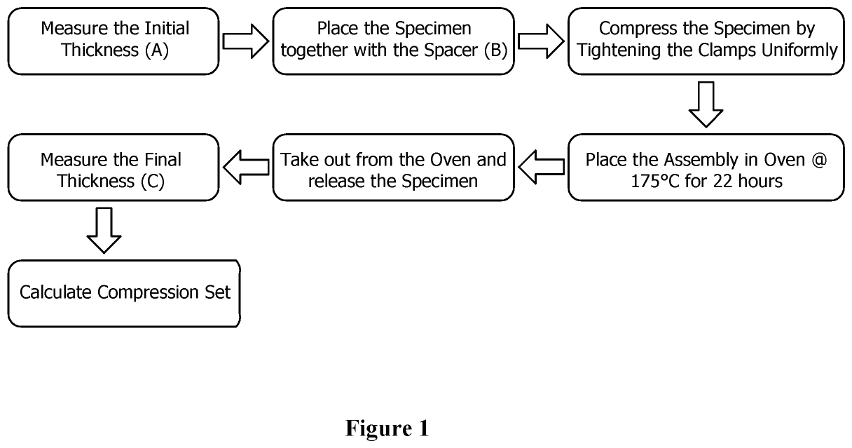

After the aging, silicone compression set and tensile properties were evaluated. Compression set testing is based on ASTM D395 method B using samples with a dimension of 13 mm in diameter and 6 mm in thickness. The test procedure is illustrated in FIG. 1. After finishing the test, the compression set can be calculated according to the ASTM D395 method B.

Tensile strain and tensile stress at break were measured using an Instron tester with a pull speed of 100 mm/min.

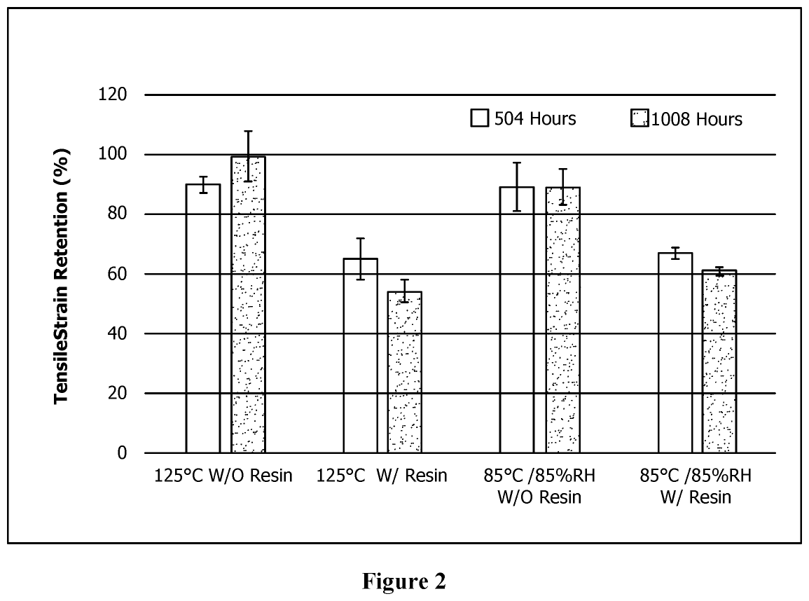

As seen from FIG. 2, when the silicone polymer composition was in contact with FRIANYL A3 GF 30 V0 resin, silicone tensile strain retention decreased to about 50-60% of the original samples at both aging conditions (temperature and relative humidity (RH)). However, the silicone polymer composition still maintained 90% and above tensile strain if not in contact with FRIANYL A3 GF 30 V0 resin at both aging conditions. This data shows that that the acid environment generated by FRIANYL A3 GF 30 V0 resin speeds up the silicone polymer composition degradation and strongly affects silicone tensile strain.

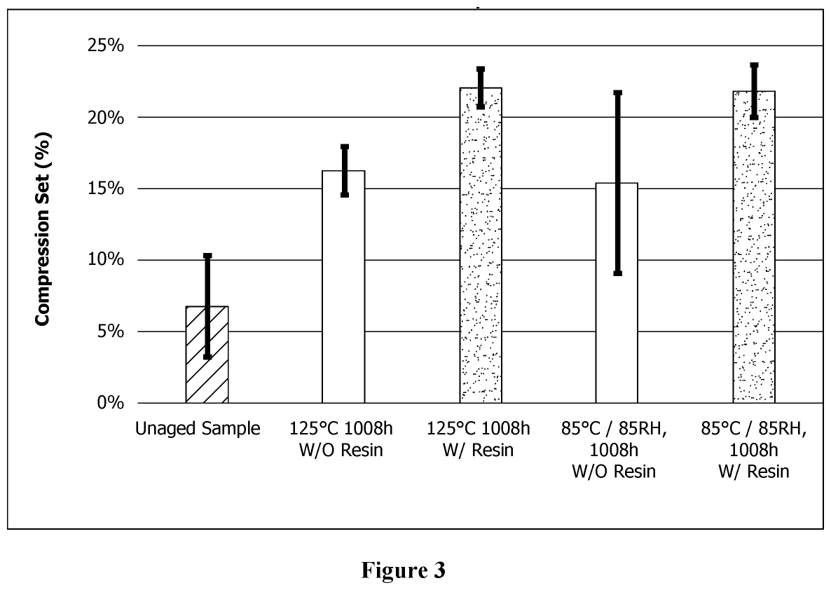

As seen from the results in FIG. 3, silicone compression set increased from the original 7% to about 15% when the silicone polymer composition is not in contact with any flame retardant composition at both aging conditions. However, silicone compression set increased from the original 7% to approximately 22% when it was in contact with FRIANYL A3 GF 30 V0 resin at both aging conditions. This means that there is an extra 7% compression set increase of silicone polymer composition when it is in contact with FRIANYL A3 GF 30 V0 resin compared with the samples without contact to any resins. The results indicate that the acid environment generated by the FRIANYL A3 GF 30 V0 resin during heat aging speeds up the silicone polymer composition degradation and strongly affects compression set.

In another series of experiments, three samples were prepared. The first sample contained the halogen free phosphorus flame retardant resin FRIANYL A3 GF 30 V0 resin, available from Celanese. The second sample included the halogen free phosphorus flame retardant FRIANYL A3 GF 30 V0 with 5% by weight of magnesium oxide. The third sample included the FRIANYL A3 GF 30 V0 resin with 10% by weight of magnesium oxide.

The magnesium oxide was first mixed with FRIANYL A3 GF 30 V0 resin to make the modified halogen free phosphorus-base V-0 resin. Silicone test coupons were then prepared. The test coupons were buried inside the modified halogen free phosphorus flame retardant composition and then aged at 125° C. for 504 hours and 1008 hours. After the samples were aged, the compression set testing was performed at 175° C. for 22 hours according to ASTM D395 as described above.

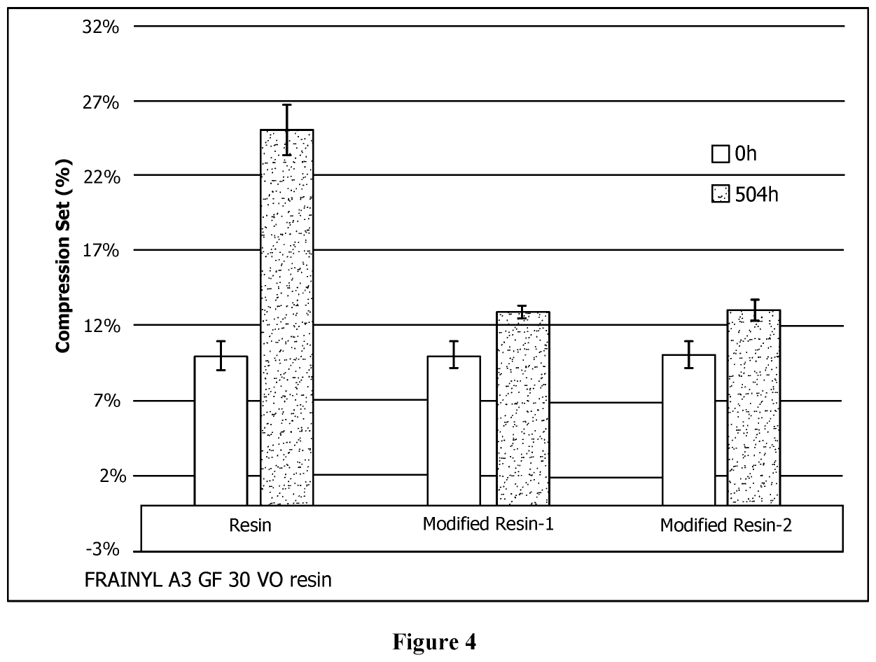

The results of the compression set testing can be found in FIG. 4. The results show that the samples with the halogen free phosphorus flame retardant resin modified with metal oxide when in contact with the silicone test coupons performed better after 504 hours at 125° C. than when the halogen free phosphorus flame retardant resin was used by itself.

These test results show that the metal oxide in the flame retardant resin acts as an acid scavenger when the halogen free phosphorus flame retardant resin is in contact with a silicone polymer composition and the silicone polymer composition is subject to thermal degradation. The addition of the metal oxide to the flame retardant ensures that the silicone polymer composition does not lose its physical properties and deteriorates in the presence of a halogen free phosphorus flame retardant resin when subject to aging or thermal degradation or other environmental conditions.

One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A halogen free flame retardant composition comprising a halogen free flame retardant resin and a metal oxide, wherein said halogen free flame retardant is mixed with said metal oxide.

2. The composition of claim 1, wherein said halogen free flame retardant resin is a halogen free phosphorus flame retardant resin.

3. The composition of claim 2, wherein said halogen free phosphorus flame retardant resin includes a phosphorus flame retardant chosen from the group consisting of phosphates, phosphonates, phosphinates, phosphinites, phosphonites, phosphites, phosphines, phosphine oxides, red phosphorus, and phosphonium compounds.

4. The composition of claim 3, wherein said halogen free phosphorus flame retardant resin includes polyethylene, polypropylene, acrylonitrile butadiene styrene, polystyrene, polyketone, polybutylene terephthalate, polyamides, polyester, polyphenylene ether, polycarbonates, polysulfones, polyaryletherketones or polyethersulfones.

5. The composition of claim 1, wherein said metal oxide is chosen from the group consisting of: aluminum oxide, antimony oxide, bismuth (III) oxide, calcium oxide, gallium (III) oxide, magnesium oxide, barium oxide, strontium oxide, zinc oxide, titanium (II) oxide, titanium (IV) dioxide, cerium dioxide, copper oxide, iron oxide, nickel oxide, manganese oxide, chromium oxide, or lead oxide.

6. The composition of claim 5, wherein said metal oxide is magnesium oxide.

7. The composition of claim 6, wherein said magnesium oxide is at least 5 wt. % of said composition.

8. The composition of claim 6, wherein said magnesium oxide is at least 10 wt. % of the of said composition.

9. The composition of claim 6, wherein said magnesium oxide is the range of about 0.5 to about 10 wt. % of the composition.

10. The composition of claim 1, wherein said composition has UL 94 V-0 rating.

11. A electronic device having a component made from silicone polymer composition and a component made from a halogen free flame retardant composition, said halogen free flame retardant composition comprising a halogen free flame retardant resin and a metal oxide, wherein said halogen free flame retardant resin is mixed with a metal oxide.

12. A electronic device of claim 11, wherein said halogen free flame retardant resin is a halogen free phosphorus flame retardant resin.

13. A electronic device of claim 12, wherein said halogen free phosphorus flame retardant resin includes phosphates, phosphonates, phosphinates, phosphinites, phosphonites, phosphites, phosphines, phosphine oxides, red phosphorus, and phosphonium compounds.

14. A electronic device of claim 13, wherein said halogen free phosphorus flame retardant resin includes polyethylene, polypropylene, acrylonitrile butadiene styrene, polystyrene, polyketone, polybutylene terephthalate, polyamides, polyester, polyphenylene ether, polycarbonates, polysulfones, polyaryletherketones or polyethersulfones.

15. The electronic device of claim 11, wherein the device has a UL 94 V-0 rating.

16. The electronic device of claim 11, wherein said metal oxide is chosen from aluminum oxide, antimony oxide, bismuth (III) oxide, calcium oxide, gallium (III) oxide, magnesium oxide, barium oxide, strontium oxide, zinc oxide, titanium (II) oxide, titanium (IV) dioxide, cerium dioxide, copper oxide, iron oxide, nickel oxide, manganese oxide, chromium oxide, or lead oxide.

17. The electronic device of claim 11, wherein said metal oxide is magnesium oxide.

18. The electronic device of claim 17, wherein said magnesium oxide is 5 wt. % of said composition.

19. The electronic device of claim 17, wherein said magnesium oxide is 10 wt. % of said composition.

20. The electronic device of claim 17, wherein said magnesium oxide is in the range of about 0.5 to about 10 wt. % of said composition.
